(19) United States
(12) Patent Application Publication
(10) Pub. No.: US 2008/0007937 A1
(43) Pub. Date: Jan. 10, 2008

(54) DIRECT-TYPE BACKLIGHT MODULE

(76) Inventors: Hung-Yi Ou Yang, Taipei County (TW); Wen-Yu Lin, Taipei City (TW); Chia-Hung Chen, Changhua County (TW); Wen-Chi Hung, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(21) Appl. No.: 11/309,182

(22) Filed: Jul. 7, 2006

(51) Int. Cl. G09F 13/04

(52) U.S. Cl. 362/97

(57) ABSTRACT

A direct-type backlight module is disclosed, which includes a frame, at least one lamp support structure, at least one lamp and a diffusion plate. The frame has a bottom plate, and at least one opening is disposed in the bottom plate. The lamp support structure including a base and at least one holding and fixing member is fixed in the opening, wherein the base is disposed outside the bottom plate of the frame, and the holding and fixing member is disposed on the base and through the opening. The holding and fixing member has a lamp holding portion and a fixing portion, wherein the fixing portion is fixed in the opening, and the lamp holding portion is suitable for holding the lamp. The diffusion plate is disposed above the lamp.

### BACKGROUND OF THE INVENTION

1. Field of Invention

The present invention relates to a light source module. More particularly, the present invention relates to a direct-type backlight module.

2. Description of Related Art

With the development of modern video technology, liquid crystal display devices have been widely applied in the screens of consumer electronic products such as liquid crystal display television (LCD TV), mobile phones, notebook computers, personal computers and personal digital assistants. However, as the liquid crystal display panel in a liquid crystal display device is incapable of emitting light, a backlight module is required to be disposed on the back of the liquid crystal display panel to provide the surface light source for the liquid crystal display panel, thus enabling the liquid crystal display panel to display images.

FIG. 1A is a spatial exploded view of a conventional direct-type backlight module. FIG. 1B is a partial sectional view of the direct-type backlight module as shown in FIG. 1A. Referring to FIGS. 1A and 1B, the conventional direct-type backlight module 100 comprises a frame 110, a plurality of cold cathode fluorescent lamps (CCFLs) 120, a diffusion plate 130 and a plurality of lamp support structures 140. The plurality of CCFLs 120 is disposed within the frame 110, and the diffusion plate 130 is disposed above the CCFLs 120, wherein the diffusion plate 130 is used to evenly distribute the light rays emitted from the CCFLs 120, so as to provide a uniform surface light source.

When the size of the direct-type backlight module 100 increases, the length of the CCFLs 120 increases correspondingly, which leads to the vibration of the direct-type backlight module 100 when being moved and is likely to damage the CCFLs 120. Therefore, the direct-type backlight module 100 generally has an additional lamp support structure 140 for holding the CCFLs 120 to further fix the CCFLs 120.

Referring to FIGS. 1A and 1B again, the frame 110 has a bottom plate 112. A plurality of openings 114 corresponding to the lamp support structures 140 is disposed in the bottom plate 112. The lamp support structures 140 are disposed on the bottom plate 112. The lamp support structure 140 comprises a base 142, two lamp holders 144 and two locking hooks 146, wherein the lamp holders 144 and the locking hooks 146 are respectively arranged on upper and lower surfaces of the base 142. The locking hooks 146 are fixed in the openings 114, such that the lamp support structures 140 are fixed to the bottom plate 112. The lamp holders 144 are used to hold the CCFLs 120.

However, as the locking hooks 146 pass through the openings 114 and protrude outside the bottom plate 112, when the direct-type backlight module 100 is assembled with other components, the locking hooks 146 may collide with other components, resulting in a structural interference. Thus the locking hooks 146 become loose and are apart from the opening 114, and the lamp support structures 140 and the bottom plate 112 may be separated, causing the damage of the CCFLs 120.

FIG. 2A is a partial sectional view of another conventional direct-type backlight module. FIG. 2B is a spatial exploded view of the support structures and the bottom plate as shown in FIG. 2A, in which the direction of the view angle of the bottom plate is the direction from outside to inside. Referring to FIGS. 2A and 2B, a conventional direct-type backlight module 200 comprises a frame 210, a plurality of CCFLs 220, a diffusion plate 230 and a plurality of lamp support structures 240 (only one of the lamp structures is shown in the figures). The frame 210 has a bottom plate 212. The lamp support structures 240 are disposed on the bottom plate 212 to hold and support the CCFLs 220. The diffusion plate 230 is disposed above the CCFLs 120.

In particular, a lamp support structure 240 comprises a base 242, two lamp holders 244 and a junction plate 246, wherein each of the two ends of the junction plate 246 has a protrusion 248. Correspondingly, an opening 214 corresponding to the shape of the junction plate 246 is disposed in the bottom plate 212, and concavities 216 corresponding to the shape of the protrusions 248 are disposed outside the bottom plate 212. After the junction plate 246 of the lamp support structure 240 passes through the opening 214, the lamp support structure 240 is rotated horizontally to fix the protrusions 248 in the concavities 216. Thereby, the lamp support structures 240 are fixed on the bottom plate 212, and the lamp holders 244 can hold and fix the CCFLs 220.

However, the lamp support structures 240 must be rotated to a fixed position to be fixed on the bottom plate 212 thus supporting the lamps. Therefore, the bottom plate 212 must be turned over during assembly to confirm that the lamp support structures 240 are assembled from the outer side of the bottom plate 212, which consumes a lot of man-hours and reduces the efficiency of assembly of the direct-type backlight module 200.

### SUMMARY OF THE INVENTION

In view of the above, one objective of the present invention is to provide a direct-type backlight module with a firm lamp support structure to support the lamp.

Furthermore, another objective of the present invention is to provide a direct-type backlight module with preferred efficiency of assembly.

In order to achieve the aforementioned or other objects, the present invention provides a direct-type backlight module, which comprises a frame, at least one lamp support structure, at least one lamp and a diffusion plate. The frame has a bottom plate, and at least one opening is disposed in the bottom plate. The lamp support structure including a base and at least one holding and fixing member is fixed in the opening, wherein the base is disposed outside the bottom plate of the frame, and the holding and fixing member is disposed on the base and passes through the opening. The holding and fixing member has a lamp holding portion and a fixing portion, wherein the fixing portion is fixed in the opening, and the lamp holding portion is suitable for holding the lamp. The diffusion plate is disposed above the lamp.

In one embodiment of the present invention, the material of the aforementioned holding and fixing member is plastic or a transparent material. According to an embodiment, the aforementioned holding and fixing member is not exposed out of the bottom plate.

The present invention provides another direct-type backlight module, which comprises a frame, at least one lamp support structure, at least one lamp and a diffusion plate. The frame has a bottom plate, and at least one opening set is disposed in the bottom plate. The lamp support structure passes through the opening set and is fixed in the opening set, wherein the opening set includes a first opening and a second opening. The lamp support structure comprises a base, at least one fixing member, and at least one lamp holder, wherein the fixing member and the lamp holders are disposed on the same side of the base. The base is disposed outside the base of the frame. The fixing member passes through the first opening and is fixed to the first opening. The lamp holders pass through the second opening. In addition, the lamps are held by the lamp holders, and the diffusion portion is disposed above the lamps.

In one embodiment of the present invention, the material of the aforementioned fixing member is plastic or a transparent material. According to an embodiment, the aforementioned fixing member is not exposed out of the bottom plate.

In one embodiment of the present invention, the material of the aforementioned lamp holder is plastic or a transparent material.

In one embodiment of the present invention, the aforementioned lamp support structure is integrated in one-piece.

In one embodiment of the present invention, the aforementioned fixing member is a locking hook, a fastening claw or a curvy claw.

In one embodiment of the present invention, the direct-type backlight module further comprises an optical film assembly disposed on the diffusion plate, such that the diffusion plate is located between the optical film assembly and the lamps. Moreover, the optical film assembly comprises at least one of another diffusion plate, a brightness enhancement plate and a prism plate.

In one embodiment of the present invention, the aforementioned lamp is a CCFL.

To sum up, in the direct-type backlight module according to the present invention, as the holding and fixing members (or the fixing members) are disposed in the frame, the holding and fixing members (or the fixing members) are prevented from being affected by external components and getting loose. Thus, the direct-type backlight module can keep a stable quality. In addition, the lamp support structures can pass through the openings (or opening set) from the outer side of the bottom plate to be assembled on the bottom plate, which facilitates the assembly and improves the efficiency of assembly of the direct-type backlight module.

In order to make aforementioned and other objects, features and advantages of the present invention comprehensible, preferred embodiments accompanied with figures are described in detail below.

### BRIEF DESCRIPTION OF THE DRAWINGS

FIG. 1A is a spatial exploded view of a conventional direct-type backlight module.

FIG. 1B is a partial sectional view of the direct-type backlight module as shown in FIG. 1A.

FIG. 2A is a partial sectional view of another conventional direct-type backlight module.

FIG. 2B is a spatial exploded view of the support structure and the bottom plate as shown in FIG. 2A.

FIG. 3A is a spatial exploded view of a direct-type backlight module according to the first embodiment of the present invention.

FIG. 3B is a partial sectional view of the direct-type backlight module of FIG. 3A after being assembled.

FIG. 3C is a spatial exploded view of the support structure and the bottom plate as shown in FIG. 3B.

FIG. 4A is a spatial exploded view of a direct-type backlight module according to the second embodiment of the present invention.

FIG. 4B is a partial sectional view of the direct-type backlight module of FIG. 4A after being assembled.

FIG. 4C is a spatial exploded view of the support structure and the bottom plate as shown in FIG. 4B.

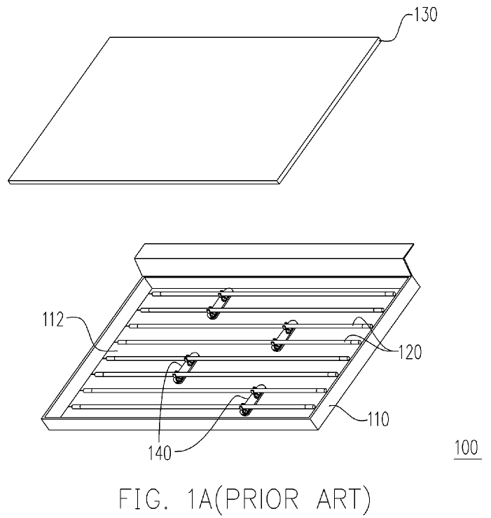

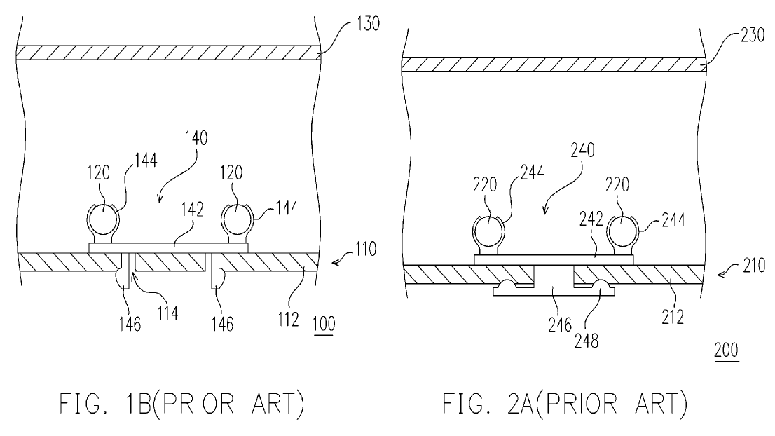

### DESCRIPTION OF EMBODIMENTS

### The First Embodiment

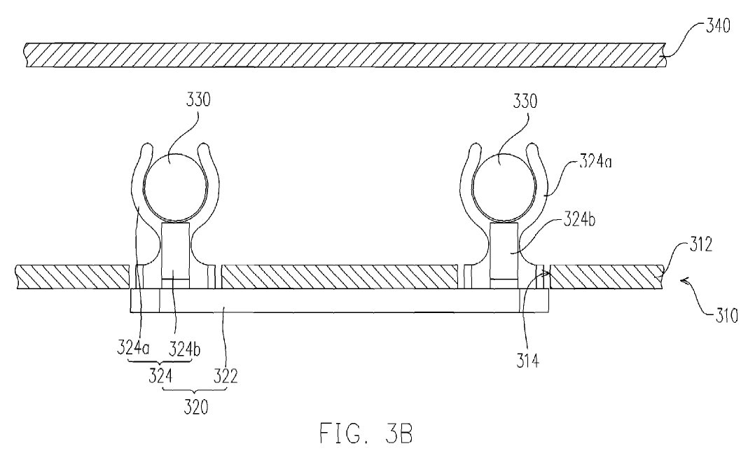

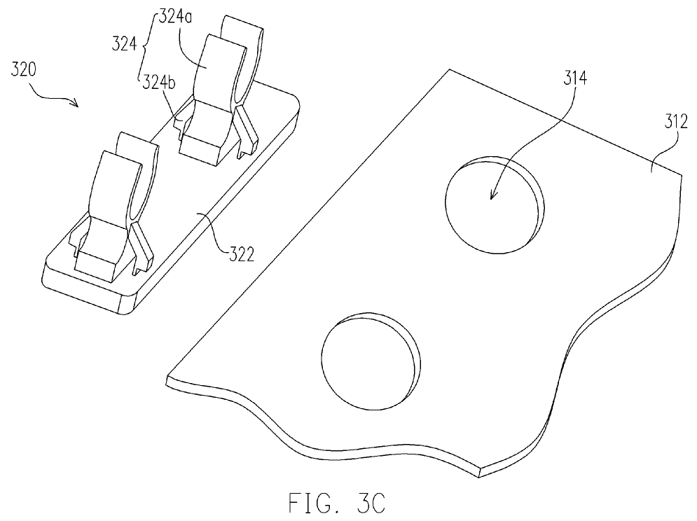

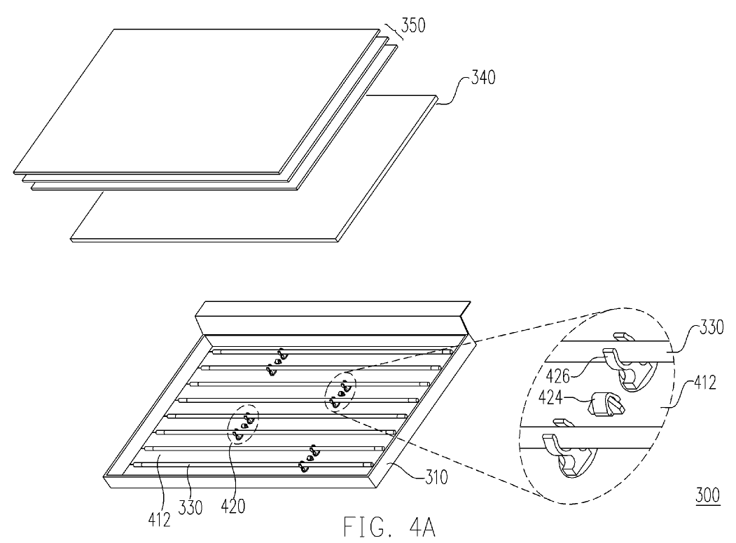

FIG. 3A is a spatial exploded view of a direct-type backlight module according to the first embodiment of the present invention. FIG. 3B is a partial sectional view of the direct-type backlight module of FIG. 3A after being assembled. FIG. 3C is a spatial exploded view of the support structure and the bottom plate as shown in FIG. 3B. Referring to FIGS. 3A, 3B and 3C together, the direct-type backlight module 300 of the present invention comprises a frame 310, at least one lamp support structure 320 (a plurality of support structures is shown in the figures), at least one lamp 330 (a plurality of lamps is shown in the figures), and a diffusion plate 340. The frame 310 has a bottom plate 312, and at least one opening 314 is disposed in the bottom plate 312. The lamp support structures 320 are fixed in the openings 314.

As described above, the lamp support structure 320 comprises a base 322 and at least one holding and fixing member 324 (two are shown in the figures). The base 322 is disposed outside the bottom plate 312 of the frame 310, and the holding and fixing members 324 are disposed on the base 322 and pass through the openings 314. Specifically, the holding and fixing member 324 has a lamp holding portion 324a and a fixing portion 324b, wherein the fixing portion 324b is fixed in the opening 314, and the lamp holding portion 324a is suitable for holding the lamp 330. The diffusion plate 340 is disposed above the lamp 330.

The holding and fixing members 324 pass through the openings 314 and are disposed in the frame 310, so the fixing portions 324b of the holding and fixing members 324 are not exposed outside the frame 312. Thus, the fixing portions 324b are prevented from being affected by external components and are getting loose. In other words, in the present invention, the components exposed outside the bottom plate 312 are the flat bases 322. In case that the bases 322 collide with external components, the structural interference of the bases 322 that leads to the separation of the lamp support structures 320 and the bottom plate 312 will not occur.

In this embodiment, the lamps 330 are, for example, CCFLs, which are suitable for providing light rays to the diffusion plate 340. The diffusion plate 340 is suitable for transforming the light rays into a uniform surface light source. Furthermore, the lamp support structures 320 are, for example, integrated in one-piece by injection molding, but the method for fabricating the support structures 320 is not limited in the present invention. Moreover, the material of holding and fixing members 324 and the bases 322 is, for example, plastic. However, in order to further improve the optical utilization rate of the direct-type backlight module 300, the material of the holding and fixing members 324 can also be a transparent material, and the material of the bases 322 can also be a highly reflective material.

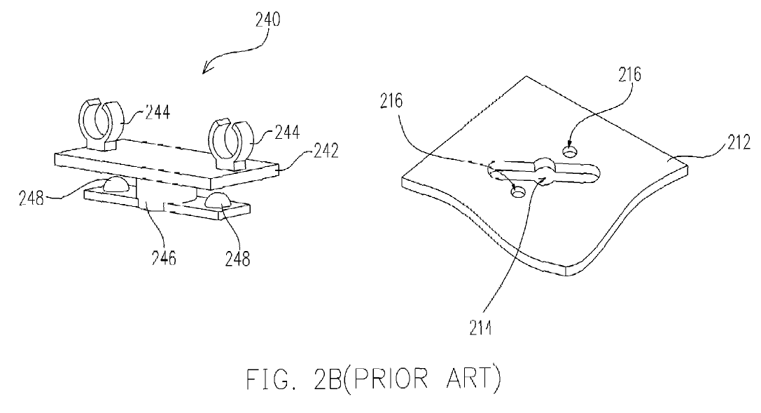

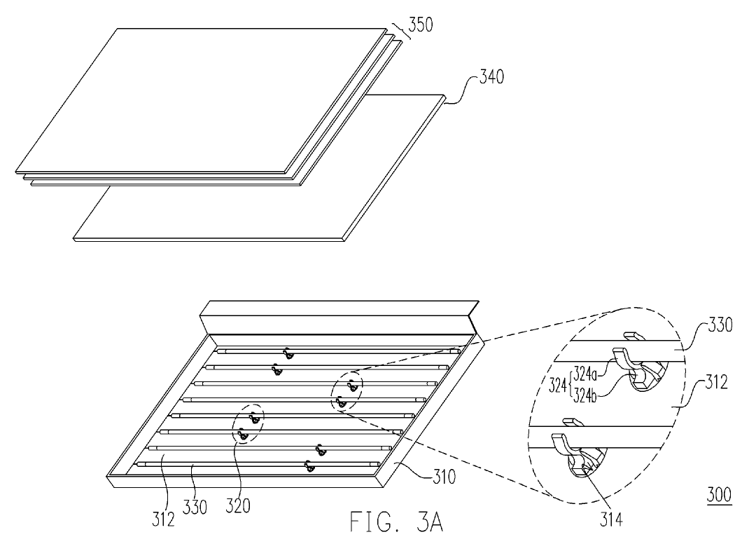

Referring to FIGS. 3B and 3C again, in the present invention, the manner of assembling lamp support structures 320 involves directly passing the holding and fixing members 324 of the support structures 320 through the openings 314 from the outside of the bottom plate 312. After the holding and fixing members 324 pass through the openings 314, the fixing portions 324b are fixed to the openings 314, such that the support structures 320 are fixed on the bottom plate 312. Therefore, compared with conventional lamp support structures 240 (as shown in FIG. 2B) that requires a manner of assembly of rotating and positioning, the manner of assembly of the lamp support structures 320 of the present invention is more simple. Moreover, in this embodiment, the fixing portion 324b is, for example, a locking hook. However, the type or form of the fixing portion 324b is not limited in the present invention. For example, the fixing portion 324b can also be a fastening claw, a curvy claw or another suitable fixing component.

Referring to FIG. 3A again, in order to further improve the optical quality of the direct-type backlight module 300, the direct-type backlight module 300 further comprises an optical film assembly 350 disposed on the diffusion plate 340, such that the diffusion plate 340 is located between the optical film assembly 350 and the light source. The optical film assembly 350 comprises at least one of another diffusion plate, a brightness enhancement plate and a prism plate to further improve the uniformity of the surface light source and to condense the surface light source thus enhancing the brightness.

It should be noted that the lamp support structure 320 in this embodiment has two holding and fixing members 324. However, the number of the holding and fixing members 324 of any lamp support structure 320 is not limited in the present invention. In addition, the holding and fixing member 324 can be disassembled into two components in accordance with different functions in the present invention, which will be illustrated below by another embodiment accompanied with drawings.

### The Second Embodiment

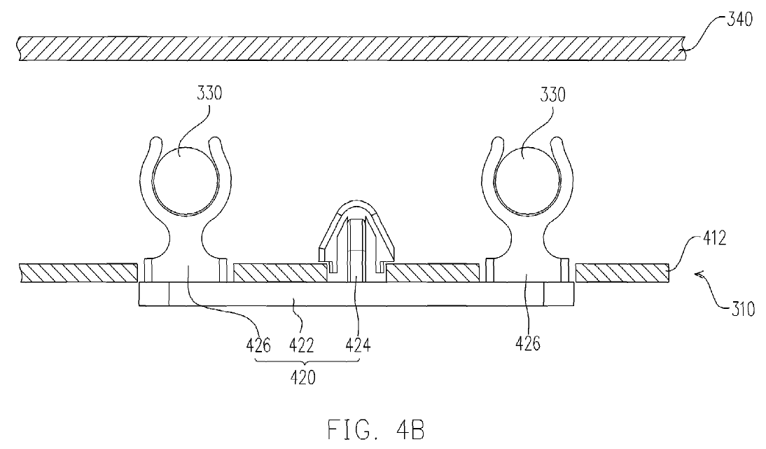

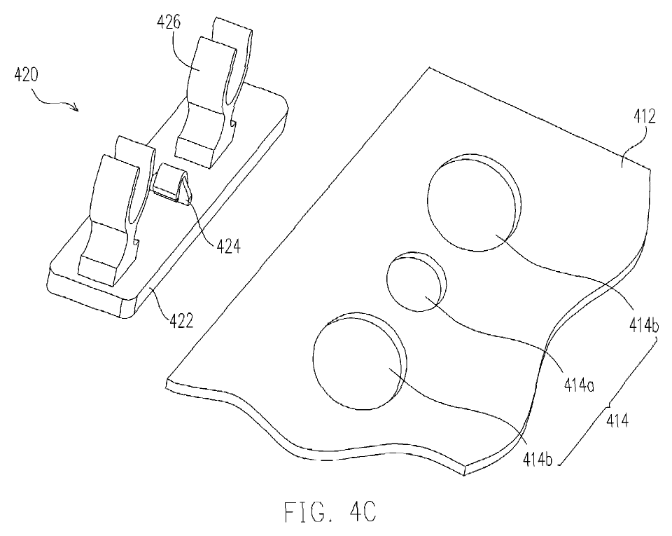

FIG. 4A is a spatial exploded view of a direct-type backlight module according to the second embodiment of the present invention. FIG. 4B is a partial sectional view of the direct-type backlight module of FIG. 4A after being assembled. FIG. 4C is a spatial exploded view of the support structure and the bottom plate as shown in FIG. 4B. Referring to FIGS. 4A, 4B and 4C together, the direct-type backlight module 400 of this embodiment is similar to the direct-type backlight module 300 of the first embodiment (as shown in FIG. 3A), while the difference lies in that the lamp support structure 420 of the direct-type backlight module 400 comprises a base 422, at least one fixing member 424 and at least one lamp holder 426 (two are shown in the figures), wherein the fixing member 424 and the lamp holders 426 are disposed on the same side of the base 422. At least one opening set 414 is disposed in the corresponding bottom plate 412, wherein the opening set 414 comprises a first opening 414a corresponding to the fixing member 424 and a second opening 414b corresponding to the lamp holder 426 (two are shown in the figures).

As described above, the lamp support structures 420 pass through the opening set 414 and are fixed in the opening set 414. In particular, the bases 422 are disposed on the outer side of the bottom plate 412, and the fixing members 424 pass through the first openings 414a and are fixed in the first openings 414a. The lamp holders 426 pass through the second openings 414b and are suitable for holding the lamps 330. As the fixing members 424 pass through the first openings 414a and are disposed in the frame 310, the fixing members 424 are not exposed outside the bottom plate 412. Therefore, the fixing members 424 are prevented from being affected by external components and getting loose.

In addition, the lamp support structures 420 are assembled by directly passing the fixing members 424 and lamp holders 426 of the support structures 420 inwardly through the first openings 414a and the second openings 414b from the outside of the bottom plate 412. The fixing members 424 are fixed in the first openings 414a after passing through the second openings 414b, so as to fix the support structures 420 on the bottom plate 412. As a result, the manner of assembly of the lamp support structures 420 of the present invention is simpler.

In this embodiment, the material of the fixing members 424 and the lamp holders 426 is plastic or a transparent material. The fixing members 424 are, for example, locking hooks, fastening claws or curvy claws. It should be mentioned that though each of the lamp hold structures 420 has a fixing member 424 fitted with two lamp holders 426 in this embodiment, the number of the fixing members 424 and the lamp holders 426 is not limited in the present invention. For example, the lamp support structure can also have two fixing members fitted with a lamp holder to improve the strength for fixing the lamp support structure on the bottom plate, and the number of the first openings and the second openings must be adjusted correspondingly.

To sum up, the direct-type backlight module at least has the following advantages:

1. As the holding and fixing members (or the fixing members) pass through the openings (or the first openings) and are disposed in the frame, the fixing portions (or the fixing members) of the holding and fixing members are not exposed outside the bottom plate, and are prevented from colliding with external components and getting loose. Thus the direct-type backlight module can maintain a stable quality.

2. The lamp support structures can pass through the openings (or opening set) from the outer side of the bottom plate to be assembled on the bottom plate, which facilitates the assembly and improves the efficiency of assembly of the direct-type backlight module.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A direct-type backlight module, comprising:
a frame, having a bottom plate with at least one opening disposed in the bottom plate;
at least one lamp support structure, fixed in the opening, wherein the lamp support structure comprises:
a base disposed outside the bottom plate of the frame;
at least one holding and fixing member disposed on the base and passing through the opening, wherein the holding and fixing member has a lamp holding portion and a fixing portion which is fixed in the opening;
at least one lamp, wherein the lamp is held by the lamp holding portion; and
a diffusion plate disposed above the lamp.

2. The direct-type backlight module as claimed in claim 1, wherein the material of the holding and fixing member is plastic or a transparent material.

3. The direct-type backlight module as claimed in claim 1, wherein the lamp support structure is integrated in one-piece.

4. The direct-type backlight module as claimed in claim 1, wherein the fixing portion is a locking hook, a fastening claw or a curvy claw.

5. The direct-type backlight module as claimed in claim 1, further comprising an optical film assembly disposed over the diffusion plate, such that the diffusion plate is located between the optical film assembly and the lamp.

6. The direct-type backlight module as claimed in claim 5, wherein the optical film assembly includes at least one of another diffusion plate, a brightness enhancement plate and a prism plate.

7. The direct-type backlight module as claimed in claim 1, wherein the lamp is a cold cathode fluorescent lamp (CCFL).

8. The direct-type backlight module as claimed in claim 1, wherein the holding and fixing member is not exposed outside the bottom plate.

9. A direct-type backlight module, comprising:
a frame, having a bottom plate with at least one opening set disposed in the bottom plate, wherein the opening set comprises a first opening and a second opening;
at least one lamp support structure passing through the opening set and fixed in the opening set, wherein the lamp support structure comprises:
a base disposed outside the bottom plate of the frame;
at least one fixing member disposed on the base, wherein the fixing member passes through the first opening and is fixed in the first opening;
at least one lamp holder disposed on the base and passing through the second opening;
at least one lamp held by the lamp holder; and
a diffusion plate disposed above the lamp.

10. The direct-type backlight module as claimed in claim 9, wherein the material of the fixing member is plastic or a transparent material.

11. The direct-type backlight module as claimed in claim 9, wherein the material of the lamp holder is plastic or a transparent material.

12. The direct-type backlight module as claimed in claim 9, wherein the lamp support structure is integrated in one-piece.

13. The direct-type backlight module as claimed in claim 9, wherein the fixing member is a locking hook, a fastening claw or a curvy claw.

14. The direct-type backlight module as claimed in claim 9, further comprising an optical film assembly disposed over the diffusion plate, such that the diffusion plate is located between the optical film assembly and the lamp.

15. The direct-type backlight module as claimed in claim 14, wherein the optical film assembly comprises at least one of another diffusion plate, a brightness enhancement plate and a prism plate.

16. The direct-type backlight module as claimed in claim 9, wherein the lamp is a CCFL.

17. The direct-type backlight module as claimed in claim 9, wherein the fixing member is not exposed outside the bottom plate.
